(19) United States
(12) Patent Application Publication
(10) Pub. No.: US 2025/0142410 A1
(43) Pub. Date: May 1, 2025

(54) RECONFIGURATION OF MODEM DEVICES TO LIMIT CHANNEL BONDING CAPACITY

(71) Applicant: Charter Communications Operating, LLC, St. Louis, MO (US)

(72) Inventors: Ryan Harter, Castle Rock, CO (US); Vinod Dani, Littleton, CO (US)

(21) Appl. No.: 18/497,462

(22) Filed: Oct. 30, 2023

(51) Int. Cl. H04W 28/08; H04L 5/00; H04L 27/26; H04W 76/15

(52) U.S. Cl. CPC H04W 28/0858; H04L 5/0073; H04L 27/26025; H04W 76/15

(57) ABSTRACT

Information indicative of a current value of a channel bonding parameter of a modem device is sent from a modem device to a network entity. The channel bonding parameter controls a maximum quantity of secondary channels the modem device can bond. Responsive to sending the information, information indicative of a replacement value for the channel bonding parameter of the modem device is received. The replacement value is less than the current value. The current value of the channel bonding parameter is replaced with the replacement value. Based on the replacement value of the channel bonding parameter, a number of secondary channels less than or equal to the replacement value of the channel bonding parameter are bonded.

### BACKGROUND

In the context of cable networking, a “channel” generally refers to a specific path or route for data transmission. A channel can include one, or more, data carriers. Carriers refer to specific frequencies or frequency ranges over which data is conveyed. Recent developments in the field of cable networking have led to the creation of high-bandwidth uplink channels that can convey much more uplink information than previous approaches. For example, a high-bandwidth uplink channel, such as a highly-multiplexed Orthogonal Frequency-Division Multiplexing (OFDM) channel, has a greater uplink capacity than a “legacy” uplink channel type, such as a Single-Carrier Quadrature Amplitude Modulation (QAM) channel.

### SUMMARY

Impairment of one or more high-bandwidth uplink channels bonded by a modem device can be detected. The modem device can receive instructions from a network entity to reduce a secondary channel bonding limit of the modem device that controls a maximum quantity of secondary uplink channels the modem device can bond. The modem device can be configured to bond secondary uplink channels in response to impairment of one or more high-bandwidth uplink channels. The modem can bond a number of secondary uplink channels less than or equal to the channel bonding limit.

In one implementation, a method is provided. The method includes sending, by a modem device to a network entity, information indicative of a current value of a channel bonding parameter of the modem device that controls a maximum quantity of secondary uplink channels the modem device can bond, wherein the modem device bonds secondary uplink channels in response to impairment of one or more high-bandwidth uplink channels. The method includes, responsive to sending the information, receiving, by the modem device from the network entity, information indicative of a replacement value for the channel bonding parameter of the modem device, wherein the replacement value is less than the current value. The method includes replacing, by the modem device, the current value of the channel bonding parameter with the replacement value. The method includes, based on the replacement value of the channel bonding parameter, bonding, by the modem device, a number of secondary uplink channels less than or equal to the replacement value of the channel bonding parameter of the modem device.

In another implementation, a computing system is provided. The computing system includes a memory, and processor device(s) coupled to the memory. The processor device(s) are to receive, from a modem device, information indicative of a current value of a channel bonding parameter of the modem device that controls a maximum quantity of secondary uplink channels the modem device can bond. The processor device(s) are further to determine a replacement value for the channel bonding parameter of the modem device based at least in part on contextual information indicative of a current secondary uplink channel availability and/or a predicted secondary uplink channel availability. The processor device(s) are further to provide instructions to the modem device to replace the current value of the channel bonding parameter with the replacement value.

In another implementation, a non-transitory computer-readable storage medium is provided. The non-transitory computer-readable storage medium includes executable instructions to cause a processor device to detect impairment of one or more high-bandwidth uplink channels bonded by the modem device. The instructions further cause the processor device to receive, from a network entity, information indicative of instructions to reduce a channel bonding limit of the modem device that controls a maximum quantity of secondary uplink channels the modem device can bond, and wherein the modem device is configured to bond secondary uplink channels in response to impairment of one or more high-bandwidth uplink channels. The instructions further cause the processor device to, based on the channel bonding limit, bond a number of secondary uplink channels less than or equal to the channel bonding limit.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1A is a block diagram of an environment suitable for implementing reconfiguration of modem devices to limit channel bonding capacity at a first time T1 according to some implementations of the present disclosure.

FIG. 1B is a block diagram of the environment suitable for implementing the reconfiguration of modem devices to limit channel bonding capacity at a second time T2 according to some implementations of the present disclosure.

FIG. 2 is a communication flow diagram between a modem device and network entity to dynamically apply and/or adjust a channel bonding capacity of the modem device according to some implementations of the present disclosure.

FIG. 3 depicts a flow chart diagram of an example method to reconfigure a modem device to limit the modem device's channel bonding capacity according to some implementations of the present disclosure.

FIG. 4 depicts a flow chart diagram of an example method to reconfigure a modem device to limit the modem device's channel bonding capacity according to some other implementations of the present disclosure.

FIG. 5 depicts a flow chart diagram of an example method to bond secondary uplink channels based on a pre-configured channel bonding limit of a modem device according to some implementations of the present disclosure.

FIG. 6 is a block diagram of the computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

As mentioned previously, in the context of cable networking, a “channel” generally refers to a specific path or route for data transmission. A channel can include one, or more, data carriers. Carriers refer to specific frequencies or frequency ranges over which data is conveyed. Recent developments in the field of cable networking have led to the creation of high-bandwidth uplink channels that can convey much more uplink information than previous approaches. For example, a high-bandwidth uplink channel, such as a highly-multiplexed Orthogonal Frequency-Division Multiplexing (OFDM) channel, has a greater uplink capacity than a “legacy” uplink channel type, such as a Single-Carrier Quadrature Amplitude Modulation (QAM) channel or a Time Division Multiple Access (TDMA) channel.

High-bandwidth uplink channels are utilized by service providers, such as Internet Service Providers (ISPs), to provide high-bandwidth network services to subscribers. These high-bandwidth uplink channels have the added benefit of enabling ISPs to offer different service tiers to subscribers. More specifically, high-bandwidth uplink channels can be assigned to subscribers that subscribe to high-bandwidth uplink services, while “legacy” or “secondary” channels (e.g., channel types that provide less bandwidth than high-bandwidth uplink channels, channel types developed prior to the high-bandwidth uplink channels, etc.) can be assigned to subscribers that do not subscribe to high-bandwidth uplink services. In this manner, ISPs can continue to leverage existing infrastructure while offering improved uplink services to certain subscribers.

ISP subscriber devices generally utilize a modem, or similar device, that converts analog data signals to a digital form (and vice-versa) for transmission and reception of information via the network. To transmit uplink information, a modem device can bond uplink channels. “Bonding” uplink channels, as described herein, refers to combining multiple channels within the same frequency band to increase overall uplink throughput. The number of channels bound by the modem device can vary based on the channel type of the channels. For example, if high-bandwidth uplink channels are available, the modem device may only need to bind a relatively small number of the channels to provide high-bandwidth uplink services. However, if only secondary channels are available, the modem device may need to bind a large number of the secondary channels to provide the same degree of bandwidth.

Some types of high-bandwidth uplink channels are particularly susceptible to impairment. For example, ODFM channel impairment can be caused due to the heightened Radio Frequency (RF) sensitivity inherent to Orthogonal Frequency-Division Multiple Access (OFDMA) channels. If high-bandwidth uplink channels fail, or are otherwise impaired, a cable modem (e.g., a Cable Modem Termination System (CMTS), a network node, etc.) can bond the secondary uplink channels utilized by subscribers that do not subscribe to high-bandwidth uplink channels. In this manner, secondary uplink channels can be utilized as a fallback in the case of high-bandwidth uplink channel impairment.

When utilizing secondary uplink channels as a fallback, many conventional modem devices will, by default, attempt to bond as many secondary uplink channels as necessary to match the bandwidth previously provided via bonding of the high-bandwidth uplink channels. However, because the bandwidth capability of a high-bandwidth uplink channel is substantially greater than that of a secondary uplink channel, a modem device must bond multiple secondary uplink channels to match a single high-bandwidth uplink channel. When each modem device experiencing channel impairment attempts to bond large quantities of secondary channels, secondary channel overutilization can quickly occur, which in turn can substantially degrade network performance.

A solution to secondary channel utilization is to place limits on the number of secondary uplink channels that a modem device can bond. However, most conventional modem devices lack such limits. Instead, the number of secondary channels a conventional modem can bond during impairment scenarios is only limited by the hardware resources of the modem device. Although some conventional modem devices do include channel bonding limits, these limits are usually not designed to reduce overutilization and are thus insufficiently limiting. This problem is exacerbated by the difficulty of reconfiguring existing modem devices to either add a channel bonding limit or reduce an existing channel bonding limit. More specifically, the channel bonding behavior of conventional modem devices is often controlled by the firmware of the device, which can be prohibitively difficult to modify.

Accordingly, implementations of the present disclosure propose reconfiguration of modem devices to limit channel bonding capacity in impairment scenarios. More specifically, assume that the configuration information for a modem device includes a channel bonding parameter. The channel bonding parameter can control a maximum quantity of secondary uplink channels that the modem device can bond in response to impairment of high-bandwidth uplink channel(s). The modem device can signal the current value of the channel bonding parameter to a network entity. For example, the modem device can send the current value of the channel bonding parameter based on information received at the modem device, such as a query from the network entity, a detection of channel impairment, etc.).

In response, the modem device can receive a replacement value from the network entity for the channel bonding parameter that is less than the current value. The modem device can replace the current value of the channel bonding parameter with the replacement value. For example, the modem device can modify existing configuration information to replace the current value of the channel bonding parameter with the replacement value. For another example, the modem device can modify firmware, static memory, etc. to replace the current value with the replacement value.

The modem device can bond a number of secondary uplink channels that is less or equal to the replacement value of the channel bonding parameter. In such fashion, the modem device can be dynamically reconfigured in channel impairment scenarios to mitigate, or eliminate, network degradation caused by secondary channel overutilization.

Implementations of the present disclosure provide a number of technical effects and benefits. As one example technical effect and benefit, conventional modem devices can cause substantial network performance degradation, or network failure, by overutilizing secondary uplink channels in channel impairment scenarios. However, implementations of the present disclosure can be leveraged to dynamically reconfigure modem devices to limit channel bonding capacity in impairment scenarios. By limiting the channel bonding capacity of modem devices, implementations of the present disclosure can mitigate, or eliminate, reductions in network performance associated with secondary channel utilization.

It should be noted that various implementations of the present disclosure are discussed primarily in the context of uplink channels. However, the implementations described herein are equally applicable to limit channel bonding capacity for downlink channels.

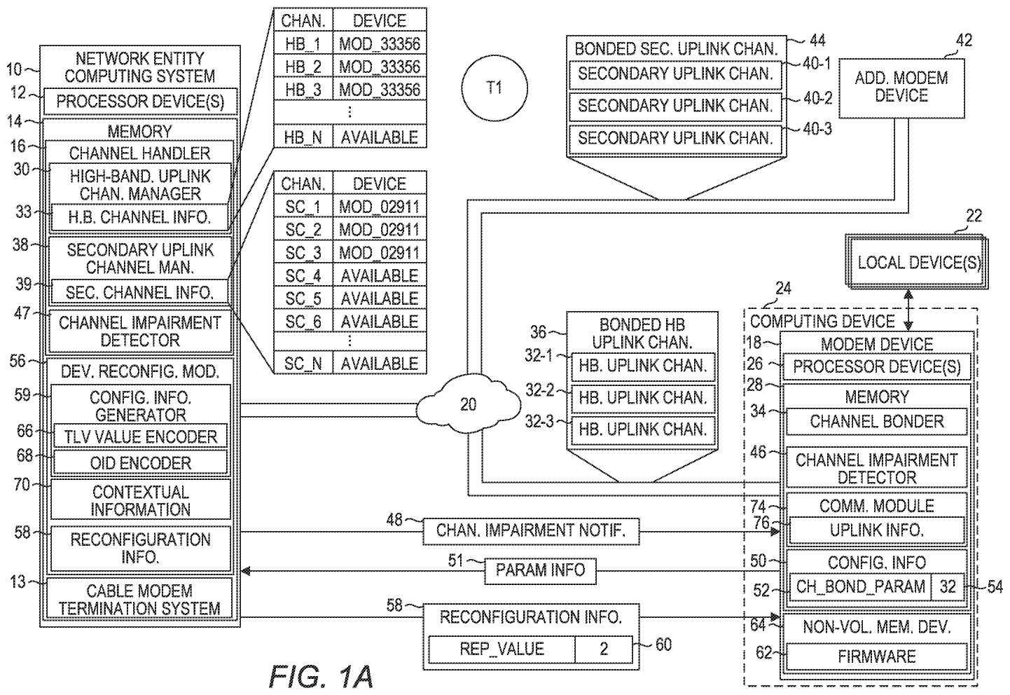

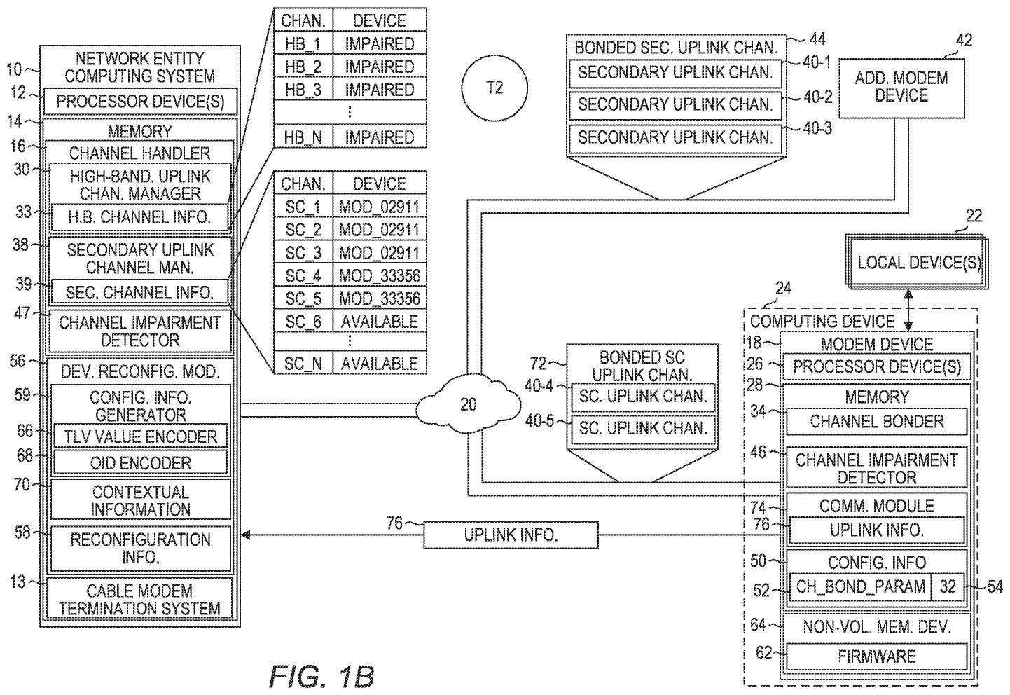

FIG. 1A is a block diagram of an environment suitable for implementing reconfiguration of modem devices to limit channel bonding capacity at a first time T1 according to some implementations of the present disclosure. In some implementations, a network entity 10 includes processor device(s) 12 and memory 14. In some implementations, the network entity 10 may be a computing system that includes multiple computing devices. Alternatively, in some implementations, the network entity 10 may be one or more computing devices within a computing environment that includes multiple distributed devices and/or systems. Similarly, the processor device(s) 12 may include any computing or electronic device capable of executing software instructions to implement the functionality described herein.

To more clearly illustrate various implementations of the present disclosure, the network entity 10 is illustrated as a computing system and will be referred to interchangeably as both a computing system and network entity as described herein. However, the network entity 10 can be, or otherwise include, a variety of computing device(s) and/or network-specific device(s). For example, in some implementations, the network entity 10 can be a computing system that includes a Cable Modem Termination System (CMTS) 13 (e.g., as a virtualized device, as a collection of hardware resources, as a specific CMTS device, etc.). Alternatively, in some implementations, the network entity 10 can be the CMTS 13.

Alternatively, in some implementations, the network entity 10 can be a computing device or system that is communicatively coupled to the cable modem termination system (e.g., via existing wired or wireless network infrastructure). More specifically, in some implementations, the network entity 10 can be a distributed network of computing device(s) and/or system(s) that collectively implement various wireless networking services of an Internet Service Provider (ISP).

The memory 14 can be or otherwise include any device(s) capable of storing data, including, but not limited to, volatile memory (random access memory, etc.), non-volatile memory, storage device(s) (e.g., hard drive(s), solid state drive(s), etc.). In particular, the memory 14 can include a containerized unit of software instructions (i.e., a “packaged container”). The containerized unit of software instructions can collectively form a container that has been packaged using any type or manner of containerization technique.

The containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

The memory 14 can include a channel handler 16. The channel handler 16 can create, implement, manage, assign, and otherwise handle downlink and uplink channels for exchanging data with wireless devices, networking devices, network nodes, endpoints, etc. Specifically, the channel handler 16 can create and assign channels to a modem device 18.

The modem device 18 can be a conventional modem device that “sits between” a local network (e.g., a home network, a business network, etc.) and a network 20 of which the computing system 10 is a network entity. The modem device 18 can be configured to receive a modulated signal over the network 20 and demodulate the modulated signal to obtain the information carried by the modulated signal. Similarly, the modem device can be configured to modulate information for transmission over the network 20.

The modem device 18 can be any type or manner of modem device. In some implementations, the modem device 18 can be a modem device utilized by a user that subscribes to internet services provided by an ISP. For example, the modem device 18 can be a cable modem that performs signal processing in conjunction with a coaxial cable network. For another example, the modem device 18 can be a wireless modem that performs signal processing in conjunction with a high-speed wireless network (e.g., a Fifth Generation (5G) New Radio (NR) network, a Fourth Generation (4G) Long-Term Evolution (LTE) network, etc.).

Specifically, in some implementations, the modem device 18 can be a standalone device that sits between a network and local device(s) 22. For example, assume that network 20 is a coaxial cable network or a hybrid network (e.g., a network that includes both coaxial cable infrastructure and fiber-optic infrastructure) utilized to provide high-speed internet services. The computing system 10 can transmit information to the modem device 18 via the network 20. The modem device 18 can receive and demodulate the information for provision to the local devices 22 (e.g., over a wired ethernet connection, over a wireless connection in conjunction with a router, etc.).

Alternatively, in some implementations, the modem device 18 can be a device included in a computing device 24 (e.g., a smartphone, an Internet-of-Things (IoT) device, a wearable device, a laptop, a tablet, etc.). For example, assume that the network 20 is a high-speed wireless network (e.g., a 5G NR wireless network, etc.). The modem device 18 can receive wireless signaling over the network 20 that carries information transmitted from the computing system 10. The modem device 18 can demodulate the information for access by other device(s) or system(s) of the computing device 24.

In some implementations, the modem device 18 can include processor device(s) 26 and a memory 28. For example, the processor device(s) 26 and the memory 28 can be the same type or manner of device(s) as described with regards to the processor device(s) 12 and the memory 14 of the computing system 10. Alternatively, the processor device(s) 26 and the memory 28 can be designed to implement various functionality of the modem device 18.

Specifically, in some implementations, the modem device 18 can be a processor device that includes multiple processor devices 26. For example, the modem device 18 can be a Central Processing Unit (CPU) that includes a processor device for handling 4G signaling and another processor device for handling 5G signaling. Alternatively, in some implementations, the modem device 18 can be a processor device included in a System-on-Chip (SoC) integrated circuit along with other processor devices (e.g., CPU cores, a Graphics Processing Unit (GPU), etc.).

As described previously, the memory 14 of the computing system 10 can include the channel handler 16. The channel handler 16 can include a high-bandwidth uplink channel manager 30. The high-bandwidth uplink channel manager 30 can manage high-speed uplink channels 32-1-32-3 (generally, high-bandwidth uplink channels 32). In particular, at the time T1, the high-bandwidth uplink channel manager 30 can provision, or otherwise assign, the high-bandwidth uplink channels 32 to the modem device 18.

The high-bandwidth uplink channel manager 30 can include high-bandwidth channel information 33. The high-bandwidth channel information 33 can indicate assignments of high-bandwidth channels to particular modem devices. To follow the depicted example, the high-bandwidth channel information 33 can indicate that channels HB_1, HB_2, and HB_3 (e.g., high-bandwidth uplink channels 32) are assigned to a modem device MOD_33356 (e.g., the modem device 18), and that channel HB_N is available for assignment. It should be noted that the high-bandwidth channel information is depicted as being assigned to a single modem device to more clearly illustrate various implementations, and that in some implementations a channel can be assigned to more than one modem device.

The memory 28 of the modem device 18 can include a channel bonder 34. The channel bonder 34 can bond multiple channels to form a bonded channel. In this manner, the channel bonder 34 can increase the total uplink throughput available to the modem device 18. To follow the depicted example, the channel bonder 34 can bond each of the high-bandwidth uplink channels 32-1-32-3 to form a bonded high-bandwidth uplink channel 36.

The memory 14 of the computing system 10 can include a secondary uplink channel manager 38. The secondary uplink channel manager 38 can manage secondary uplink channels 40-1-40-3 (generally, secondary uplink channels 40). In particular, at the time T1, the secondary uplink channel manager 38 can provision, or otherwise assign, the secondary uplink channels 40 to an additional modem device 42.

The secondary uplink channel manager 38 can include secondary channel information 39. The secondary channel information 39 can indicate assignments of secondary uplink channels to particular modem devices. To follow the depicted example, the secondary channel information 39 can indicate that channels SC_1, SC_2, and SC_3 (e.g., secondary uplink channels 40) are assigned to a modem device MOD_02911 (e.g., the additional modem device 42), and that channels SC_4, SC_5, SC_6, and SC_N are available for assignment. It should be noted that the secondary channel information is depicted as being assigned to a single modem device to more clearly illustrate various implementations, and that in some implementations a channel can be assigned to more than one modem device.

The additional modem device 42 can be a modem device that is also served by the computing system 10 via the network(s) 20. Specifically, the additional modem device 42 can be a modem device that utilizes secondary uplink channels rather than high-bandwidth uplink channels. For example, assume that the modem device 18 is associated with a subscriber that subscribes to high-bandwidth uplink services, and that the additional modem device 42 is associated with a subscriber that subscribes to lower-bandwidth uplink services. Because lower-bandwidth uplink services do not require the utilization of high-bandwidth uplink channels, the secondary uplink channel manager 38 of the computing system 10 can assign the secondary uplink channels 40 to the additional modem device 42. The additional modem device 42 can bond the secondary uplink channels 40 to form a bonded uplink channel 44.

The modem device 18 can include a channel impairment detector 46. The channel impairment detector 46 can determine if some, or all, of the channels utilized by the modem device 18 are impaired. As described herein, channel impairment generally refers to partial or complete channel performance degradation. Channel impairment can be caused by RF sensitivity, hardware failure, overutilization of channel resources, inclement weather, etc.

In some implementations, the channel impairment detector 46 can detect channel impairment for the high-bandwidth uplink channels 32 based on network performance metrics obtained by evaluating information exchanged over the bonded high-bandwidth uplink channel 36. Alternatively, in some implementations, the channel impairment detector 46 can detect channel impairment for the high-bandwidth uplink channels 36 based on information received via the computing system 10. Specifically, the memory 14 of the computing system 10 can also include a channel impairment detector 47 that is the same as, or similar to, the channel impairment detector 46 of the modem device 18. The channel impairment detector 47 can detect the channel impairment, and can send a channel impairment notification 48 to the modem device 18. Based on the channel impairment notification 48, the channel impairment detector 46 can determine that some, or all, of the high-bandwidth uplink channels 32 are impaired.

In some implementations, in response to detecting the channel impairment, the modem device 18 can send parameter information 51 to the computing system 10. The parameter information can be, include, or otherwise indicate some or all of the configuration information 50. The configuration information 50 can include a channel bonding parameter 52. The channel bonding parameter 52 can control a maximum quantity of the secondary uplink channels 40 that the modem device 18 can bond. To follow the depicted example, the configuration information 50 can include the channel bonding parameter 52. The channel bonding parameter 52 can have a current value 54 of “CH_BOND_PARAM: 32.” Based on the current value 54 of the channel bonding parameter 52, the modem device 18 can bond a maximum of 32 secondary uplink channels.

The memory 14 of the computing system 10 can include a device reconfiguration module 56. The device reconfiguration module 56 can reconfigure modem devices to modify values of channel bonding parameters. More generally, the device reconfiguration module 56 can send some manner of information to the modem device 18 to modify the modem device 18 such that the maximum quantity of secondary uplink channels the modem device 18 can bond is reduced. To do so, the device reconfiguration module 56 can generate reconfiguration information 58 with a configuration information generator 59. The reconfiguration information 58 can reconfigure various components, devices, and/or information of the modem device 18.

In some implementations, the configuration information generator 59 can generate reconfiguration information 58 that includes a replacement value 60 for the channel bonding parameter 52 of the configuration information 50. The device reconfiguration module 56 can send the reconfiguration information 58 to the modem device 18. In response, the modem device 18 can replace the current value 54 of the channel bonding parameter with the replacement value 60.

Additionally, or alternatively, in some implementations, the configuration information generator 59 can generate reconfiguration information 58 that reconfigures firmware 62 of the modem device 18. More specifically, the modem device 18 can include firmware 62. The firmware 62 can be stored on a non-volatile memory device 64. The firmware 62 can be, or otherwise include, a set of instructions that control various functions of the modem device 18, including the maximum quantity of secondary uplink channels 40 that the modem device 18 can bond. The reconfiguration information 58 can replace, or modify, existing firmware to reduce the maximum quantity of secondary uplink channels 40 that the modem device 18 can bond. For example, if the non-volatile memory device 64 is an Electrically Erasable Programmable Read-Only Memory (EEPROM), and the firmware 62 includes the channel bonding parameter 52, the reconfiguration information 58 can “flash” the firmware 62, or replace the firmware 62, to replace the current value 54 of the channel bonding parameter 52 with the replacement value 60.

In some implementations, the configuration information generator 59 can include a Type-Length-Value (TLV) encoder 66. The TLV encoder 66 can encode the replacement value 60 as a TLV and can include the TLV in the reconfiguration information 58. Additionally, or alternatively, in some implementations, the configuration information generator 59 can include an Object Identifier (OID) encoder 68. The OID encoder 68 can encode the replacement value 60 as an OID and can include the OID in the reconfiguration information 58.

As described herein, the device reconfiguration module 56 is discussed primarily within the context of replacing the value of an existing channel bonding parameter, or otherwise modifying some existing policy that limits the maximum number of channels that the modem device 18 can bond. However, the device reconfiguration module 56 can also reconfigure the modem device 18 to add the channel bonding parameter 52 and corresponding instructions if the channel bonding parameter 52 did not previously exist.

For example, assume that the channel bonding parameter 52 was not included in the configuration information 50 prior to the computing system 10 receiving the parameter information 51. The device reconfiguration module 56 can generate reconfiguration information 58 that modifies the firmware 62 to add software instructions. The added software instructions can limit the maximum quantity of secondary channels that the modem device 18 can bond based on the channel bonding parameter 52. The reconfiguration information 58 can further modify the configuration information 50 to add the channel bonding parameter 52 with the replacement value 60. In this manner, the device reconfiguration module 56 can generate reconfiguration information 58 that either reduces an existing channel bonding limit or adds a channel bonding limit to the modem device 18.

In some implementations, the device reconfiguration module 56 can determine the replacement value 60 based on contextual information 70. The contextual information 70 can indicate current and/or historical channel utilization. For example, the contextual information 70 can indicate a predicted uplink utilization by the modem device 18. For another example, the contextual information 70 can indicate a predicted uplink utilization by the additional modem device 42. For yet another example, the contextual information 70 can include predicted and/or historical secondary channel utilization, predicted and/or historical high-bandwidth channel impairment time, etc.

It should be noted that, in some implementations, the operations described herein can be performed in response to an occurrence other than detection of channel impairment. More specifically, the modem device 18 can send the parameter information 51, and can receive the reconfiguration information 58, in response to something other than detection of channel impairment. For example, the computing system may prohibit the modem device 18 from bonding any of the high-bandwidth uplink channels 32 (e.g., to prioritize those channels for some critical network function) and thus necessitate that the modem device 18 utilize the secondary uplink channels 40. For another example, a hardware or software failure of the modem device 18 may cause the modem device 18 to be unable to utilize any of the high-bandwidth uplink channels 32, and thus necessitate that the modem device 18 utilize the secondary uplink channels 40.

Turning to FIG. 1B, FIG. 1B is a block diagram of the environment suitable for implementing the reconfiguration of modem devices to limit channel bonding capacity at a second time T2 according to some implementations of the present disclosure. Specifically, in some implementations, the time T2 can be a specific point in time subsequent to, or concurrent with, the time t1. Alternatively, in some implementations, the times T2 and T1 can be periods of time, and the time period T2 can have no overlap, partial overlap, or full overlap with the time period T1.

More specifically, at the time T2, the modem device 18 can bond secondary uplink channels 40-4 and 40-5 to form a bonded secondary uplink channel 72 in response to detecting channel impairment for the high-bandwidth uplink channels 32. Conventionally, the modem device 18 may bond a large number of secondary uplink channels to match the bandwidth provided by the bonded high-bandwidth uplink channel 36. For example, if each of the high-bandwidth uplink channels provides 10 Mbps of uplink bandwidth, the bonded high-bandwidth uplink channel 36 may provide 30 Mbps of uplink bandwidth. If the secondary uplink channels 40 each provide 1 Mbps of uplink bandwidth, the modem device 18 may attempt to bond to at least 30 of the secondary uplink channels 40 to form a bonded secondary uplink channel 72 that matches the bandwidth provided by the bonded high-bandwidth uplink channel 36.

However, because the modem device 18 has been reconfigured via the reconfiguration information 58, the channel bonding capacity of the modem device 18 is limited to the value of the channel bonding parameter 52. In other words, the modem device 18 can bond a number of secondary uplink channels 40 less than or equal to the replacement value 60 (e.g., 2) of the channel bonding parameter 52. As such, the modem device 18 is limited to bonding only the secondary uplink channels 40-4 and 40-5 to form the bonded secondary uplink channel 72.

The modem device 18 can include a communication module 74. The communication module 74 can utilize the bonded secondary uplink channel 72 to transmit information to the computing system 10 over the network 20. Specifically, the communication module 74 can transmit uplink information 76 to the computing system 10. In this manner, overutilization of the secondary uplink channels 40 is mitigated, and thus, the additional modem device 42 can maintain the bonded uplink channel 44.

It should be noted that, although implementations of the present disclosure are discussed primarily in the context of uplink channels, implementations described herein can be leveraged to limit the channel bonding capacity of modems for other types of channels, such as uplink channels, control channels, etc.

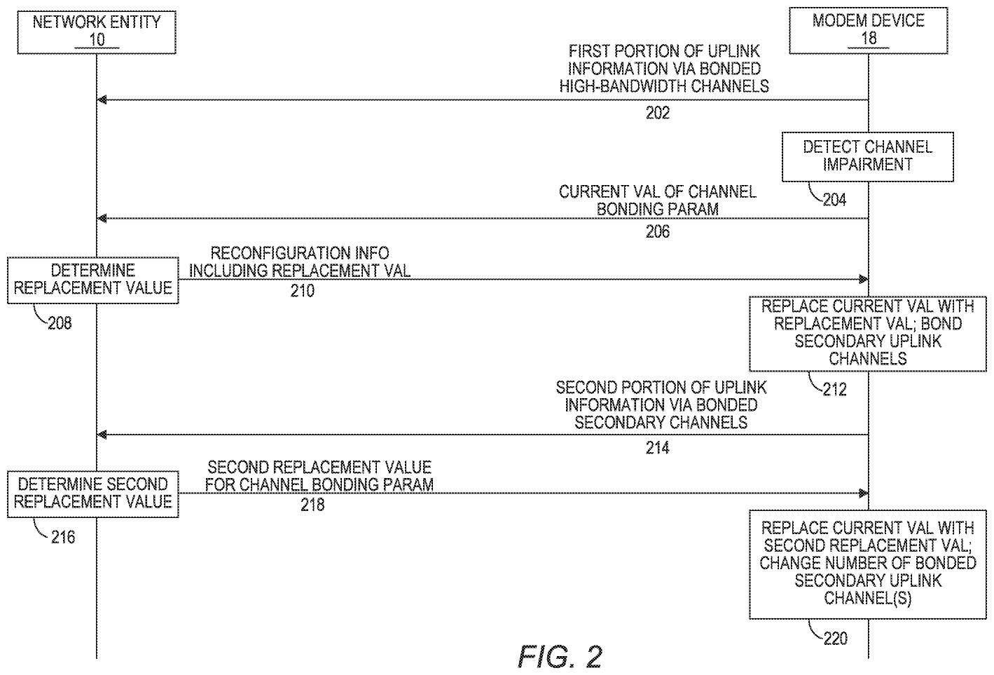

FIG. 2 is a communication flow diagram between a modem device and network entity to dynamically apply and/or adjust a channel bonding capacity of the modem device according to some implementations of the present disclosure. FIG. 2 will be discussed in conjunction with FIGS. 1A and 1B.

Specifically, at 202, the modem device 18 can provide a first portion of uplink information to the network entity 10 via bonded high-bandwidth uplink channels 36. The uplink information can be any type or manner of information that can be transmitted from the modem device 18 to the network entity 10. For example, the first portion of the uplink information can be, or include, a first portion of video data for an item of video content.

At 204, the modem device 18 can detect channel impairment for some, or all, of the bonded high-bandwidth uplink channels 36. For example, the modem device 18 can evaluate signal performance metrics for the bonded high-bandwidth uplink channels 36. Based on the signal performance metrics, the modem device 18 can determine that channel impairment has occurred. For another example, the modem device 18 can receive information indicating occurrence of channel impairment from the network entity 10.

In response to detecting the channel impairment, at 206, the modem device 18 can provide the current value 54 of the channel bonding parameter 52 to the network entity 10. Alternatively, in some implementations, if the modem device 18 lacks a channel bonding parameter 52, or any other analogous limit on the quantity of secondary channels that the modem device 18 can bond, the modem device 18 can transmit information indicating such to the network entity 10.

In response, at 208, the network entity 10 can determine a replacement value 60 for the channel bonding parameter 52. The replacement value 60 can be determined based on contextual information descriptive of current network conditions, predicted network conditions, predicted channel utilization by the modem device 18, etc. At 210, the network entity 10 can transmit reconfiguration information 58 to the modem device 18. The reconfiguration information 58 can include the replacement value 60. The reconfiguration information 58 can be configured to apply the replacement value 60 in a manner that limits the number of secondary channels the modem device 18 can bond to that of the replacement value 60.

At 212, the modem device 18 can replace the current value 54 of the channel bonding parameter 52 with the replacement value 60. For example, if the channel bonding parameter 52 is stored in the configuration information 50, the modem device 18 can modify the configuration information 50 to replace the current value of the channel bonding parameter 52 with the replacement value 60. For another example, if the channel bonding parameter 52 is included in the firmware 62, the modem device 18 can modify the firmware 62 or replace the firmware 62 to replace the current value 54 of the channel bonding parameter 52 with the replacement value 60.

At 214, the modem device 18 can transmit the second portion of the uplink information to the network entity 10 via the bonded secondary uplink channels.

At 216, the network entity 10 can determine a second replacement value for the channel bonding parameter 52. The second replacement value can be determined in response to a change in network conditions. For example, assume that only some of the high-bandwidth uplink channels 32 were impaired when the first replacement value was determined at 208. If additional high-bandwidth uplink channels suffer impairment at 216, the network entity 10 can determine a second replacement value that further reduces the maximum quantity of secondary uplink channels that the modem device can bond. Alternatively, if some of the impaired high-bandwidth uplink channels are no longer impaired at 216, the network entity 10 can determine a second replacement value that increases the maximum quantity of secondary uplink channels that the modem device can bond.

At 218, the network entity 10 can provide the second replacement value for the channel bonding parameter 52 to the modem device 18. At 220, the modem device 18 can replace the replacement value received at 210 with the second replacement value. Based on the second replacement value, the modem device 18 can bond additional secondary uplink channels or can un-bond one or more of the currently bonded secondary uplink channels. In such fashion, the modem device 18 and the network entity 10 can communicate to dynamically modify the value of the channel bonding parameter based on current and/or predicted network conditions.

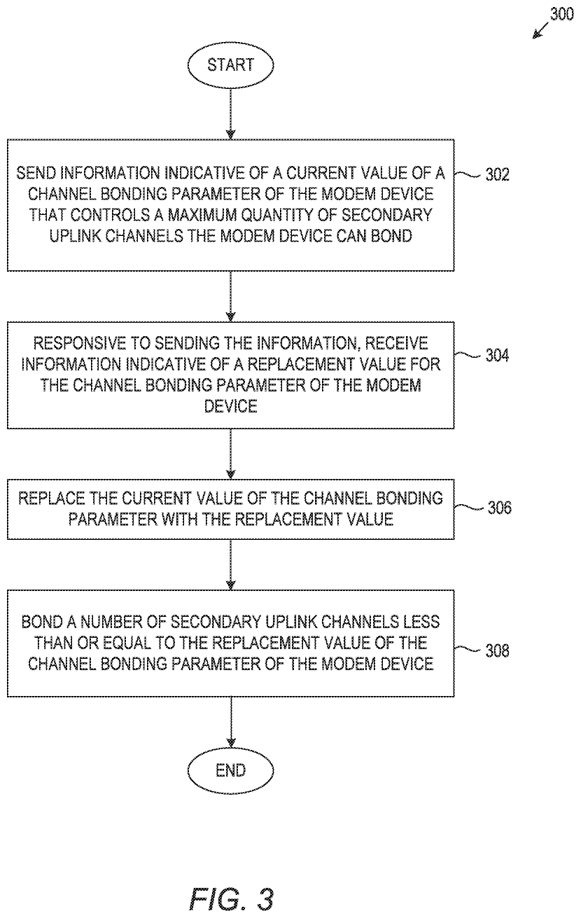

FIG. 3 depicts a flow chart diagram of an example method 300 to reconfigure a modem device to limit the modem device's channel bonding capacity according to some implementations of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a modem device can send information indicative of a current value of a channel bonding parameter of the modem device to a network entity. The channel bonding parameter can control a maximum quantity of secondary channels (e.g., uplink, downlink, control, etc.) the modem device can bond. The modem device can bond secondary channels, such as secondary uplink channels, in response to impairment of one or more high-bandwidth channels, such as high-bandwidth uplink channels.

In some implementations, prior to sending the information, the modem device can send a first portion of information via one or more high-bandwidth channels. The modem device can detect channel impairment for the one or more high-bandwidth channels. Based on detecting the channel impairment, the modem device can determine to switch from the one or more high-bandwidth channels to the secondary channels.

In some implementations, the modem device can detect the channel impairment for the one or more high-bandwidth channels by detecting occurrence of Orthogonal Frequency-Division Multiplexing (OFDM) channel impairment. Alternatively, the modem device can receive information from the network entity indicating the channel impairment for the one or more high-bandwidth channels.

At 304, the modem device can, responsive to sending the information, receive information from the network entity. The information can indicate a replacement value for the channel bonding parameter of the modem device that is less than the current value.

At 306, the modem device can, based on the replacement value of the channel bonding parameter, bond a number of secondary channels less than or equal to the replacement value of the channel bonding parameter of the modem device.

In some implementations, to replace the current value of the channel bonding parameter, the modem device can apply a modification to configuration information of the modem device. The configuration information can include the channel bonding parameter and the modification can replace the current value of the channel bonding parameter with the replacement value.

Alternatively, in some implementations, the modem device can apply a modification to firmware of the modem device that includes the channel bonding parameter. The modification can replace the current value of the channel bonding parameter with the replacement value.

Additionally, or alternatively, in some implementations, the modem device can apply a modification to a non-volatile memory device of the modem device. The non-volatile memory device can include the channel bonding parameter. The modification can replace the current value of the channel bonding parameter with the replacement value. In some implementations, the network entity can be, or otherwise include, a CMTS.

In some implementations, to bond the secondary uplink channels, the modem device can, based on the replacement value for the channel bonding parameter, bond a number of Data over Cable Service Interface Specification (DOCSIS) channels less than or equal to the replacement value of the channel bonding parameter of the modem device.

Additionally, or alternatively, in some implementations, to bond the secondary uplink channels, the modem device can, based on the replacement value for the channel bonding parameter, bond a number of single-carrier Quadrature Amplitude Modulation (QAM) channels less than or equal to the replacement value of the channel bonding parameter of the modem device.

Additionally, or alternatively, in some implementations, to bond the secondary uplink channels, the modem device can, based on the replacement value for the channel bonding parameter, bond a number of Time-Division Multiple Access (TDMA) channels less than or equal to the replacement value of the channel bonding parameter of the modem device.

In some implementations, the modem device can further send a second portion of the information via the number of secondary channels less than or equal to the replacement value.

In some implementations, the modem device can further receive, from the network entity, information indicative of a second replacement value for the channel bonding parameter of the modem device. The second replacement value can be different than the replacement value. The modem device can replace the replacement value of the channel bonding parameter with the second replacement value. Based on the second replacement value for the channel bonding parameter, the modem device can bond a second number of secondary channels less than or equal to the second replacement value of the channel bonding parameter of the modem device.

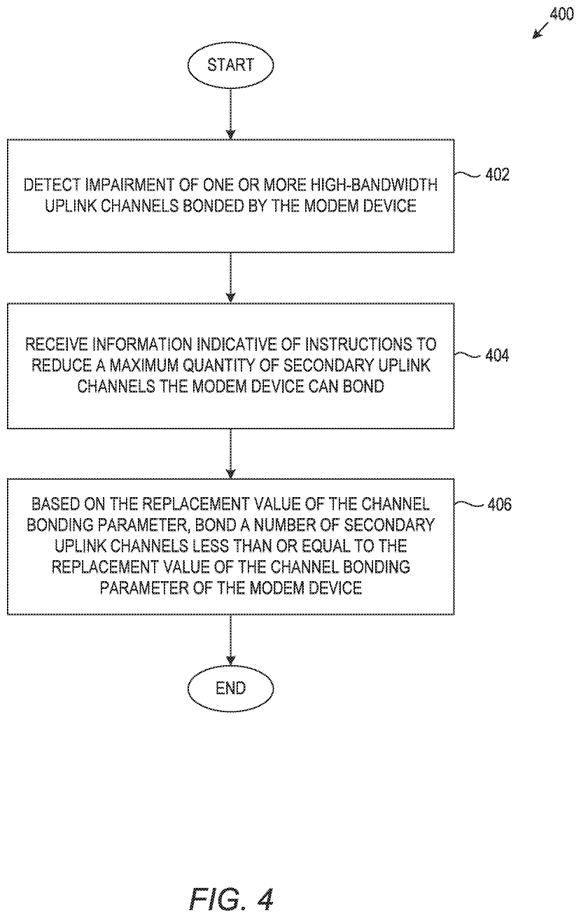

FIG. 4 depicts a flow chart diagram of an example method 400 to reconfigure a modem device to limit the modem device's channel bonding capacity according to some other implementations of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a modem device can detect impairment of one or more high-bandwidth uplink channels bonded by the modem device. For example, the modem device can detect channel impairment for the high-bandwidth uplink channel(s) based on network performance metrics. For another example, the modem device can detect channel impairment for the high-bandwidth uplink channel(s) based on information received from a network entity (e.g., a CMTS, etc.).

At 404, the modem device can receive information indicative of instructions to reduce a channel bonding limit that controls a maximum quantity of secondary uplink channels the modem device can bond. More specifically, the modem device can bond secondary uplink channels in response to impairment of high-bandwidth uplink channels. The number of secondary uplink channels that can be bonded by the modem device is limited by the channel bonding limit.

In some implementations, the channel bonding limit can be, or can otherwise include, the channel bonding parameter discussed herein. Alternatively, in some implementations, the channel bonding limit can be implemented in some other manner. For example, if the modem includes a plurality of devices that can each be utilized to bond a certain number of secondary uplink channels, then some of the plurality of devices can be disabled in order to reduce the channel bonding limit. For another example, if the modem automatically bonds a number of secondary uplink channels sufficient to match the previous bandwidth provided by high-bandwidth uplink channels, the channel bonding limit may be reduced by modifying the value of the previous bandwidth such that the modem can “match” the modified bandwidth by bonding a small number of secondary uplink channels.

At 406, the modem device can, based on the channel bonding limit, bond a number of secondary uplink channels less than or equal to the channel bonding limit.

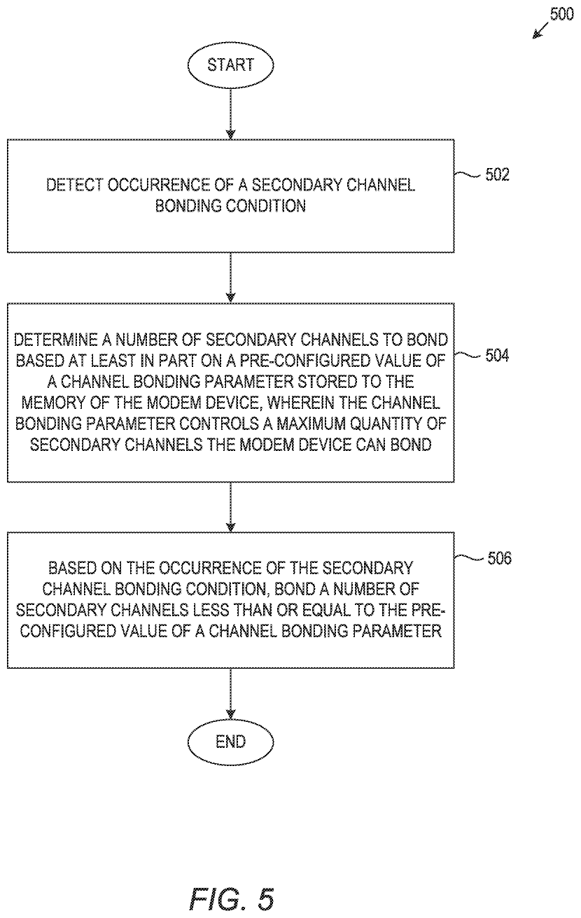

FIG. 5 depicts a flow chart diagram of an example method 500 to bond secondary uplink channels based on a pre-configured channel bonding limit of a cable modem device according to some implementations of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, a cable modem device can detect occurrence of a secondary channel bonding condition. The secondary channel bonding condition can be any type or manner of occurrence that causes the modem device to bond secondary channels. For example, the modem device can detect occurrence of a secondary channel bonding condition if another network device (e.g., a CMTS) instructs the modem device to bond secondary channels. For another example, the modem device can detect occurrence of the secondary channel bonding condition by detecting impairment of high-bandwidth channels. For another example, the modem device can detect occurrence of the secondary channel bonding condition by determining that available channels are insufficient to provide a certain bandwidth. Specifically, the modem device can detect occurrence of the secondary channel bonding condition while utilizing, and/or while continuing to utilize, high-bandwidth channels for transmitting information.

At 504, the cable modem device can determine a number of secondary channels (e.g., DOCSIS-compatible secondary channels) to bond based at least in part on a pre-configured value of a channel bonding parameter. The channel bonding parameter, and the pre-configured value, can be stored to the memory of the modem device. The channel bonding parameter can control a maximum quantity of secondary channels the modem device can bond. For example, if the pre-configured value is five, the modem device can bond a maximum of five secondary channels (e.g., secondary uplink channels, secondary downlink channels, etc.).

At 506, based on the occurrence of the secondary channel bonding condition, the modem device can bond the number of secondary channels. The number of secondary channels can be less than or equal to the pre-configured value of the channel bonding parameter.

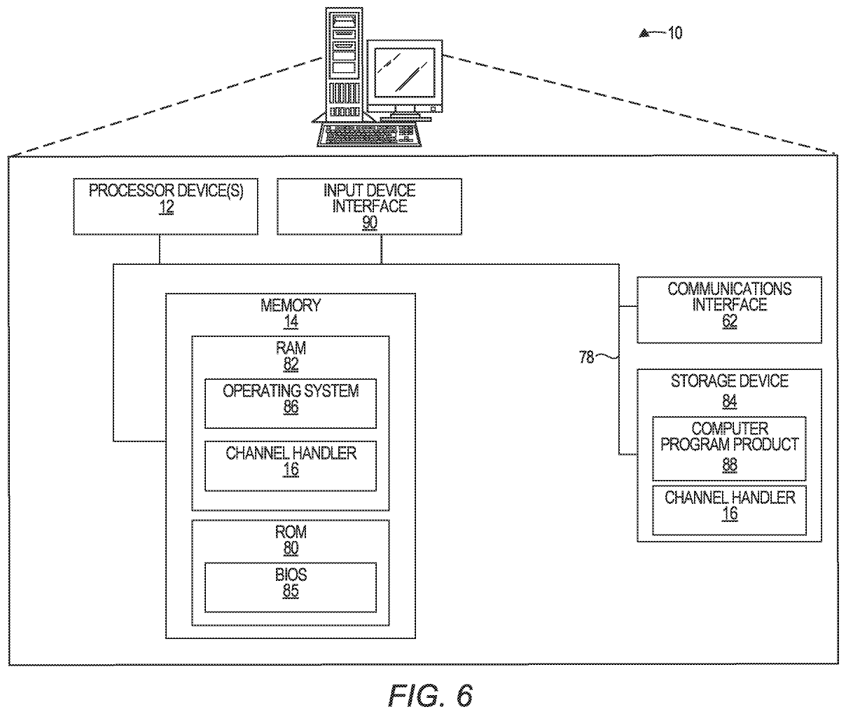

FIG. 6 is a block diagram of the computing system 10 suitable for implementing examples according to one example. The computing system 10 may comprise any computing or electronic device capable of including firmware, hardware, and/or executing software instructions to implement the functionality described herein, such as a computer server, a desktop computing device, a laptop computing device, a smartphone, a computing tablet, or the like. In particular, the computing system 10 can be, or otherwise include, physical and/or virtualized network-specific devices, such as a Cable Modem Termination System. Additionally, or alternatively, in some implementations, the computing system can be a system, or node, within a network that facilitates provision of internet services to subscribers.

The computing system 10 includes the processor device(s) 12, the memory 14, and a system bus 78. The system bus 78 provides an interface for system components including, but not limited to, the memory 14 and the processor device(s) 12. The processor device(s) 12 can be any commercially available or proprietary processor.

The system bus 78 may be any of several types of bus structures that may further interconnect to a memory bus (with or without a memory controller), a peripheral bus, and/or a local bus using any of a variety of commercially available bus architectures. The memory 14 may include non-volatile memory 80 (e.g., read-only memory (ROM), erasable programmable read-only memory (EPROM), electrically erasable programmable read-only memory (EEPROM), etc.), and volatile memory 82 (e.g., random-access memory (RAM)). A basic input/output system (BIOS) 85 may be stored in the non-volatile memory 80 and can include the basic routines that help to transfer information between elements within the computing system 10. The volatile memory 82 may also include a high-speed RAM, such as static RAM, for caching data.

The computing system 10 may further include or be coupled to a non-transitory computer-readable storage medium such as the storage device 84, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 84 and other drives associated with computer-readable media and computer-usable media may provide non-volatile storage of data, data structures, computer-executable instructions, and the like.

A number of modules can be stored in the storage device 84 and in the volatile memory 82, including an operating system 86 and one or more program modules, such as the channel handler 16, which may implement the functionality described herein in whole or in part. All or a portion of the examples may be implemented as a computer program product 88 stored on a transitory or non-transitory computer-usable or computer-readable storage medium, such as the storage device 84, which includes complex programming instructions, such as complex computer-readable program code, to cause the processor device(s) 12 to carry out the steps described herein. Thus, the computer-readable program code can comprise software instructions for implementing the functionality of the examples described herein when executed on the processor device(s) 12. The processor device(s) 12, in conjunction with the channel handler 16 in the volatile memory 82, may serve as a controller, or control system, for the computing system 10 that is to implement the functionality described herein.

Because the channel handler 16 is a component of the computing system 10, functionality implemented by the channel handler 16 may be attributed to the computing system 10 generally. Moreover, in examples where the channel handler 16 comprises software instructions that program the processor device(s) 12 to carry out functionality discussed herein, functionality implemented by the channel handler 16 may be attributed herein to the processor device(s) 12.

An operator, such as a user, may also be able to enter one or more configuration commands through a keyboard (not illustrated), a pointing device such as a mouse (not illustrated), or a touch-sensitive surface such as a display device. Such input devices may be connected to the processor device(s) 12 through an input device interface 90 that is coupled to the system bus 78 but can be connected by other interfaces such as a parallel port, an Institute of Electrical and Electronic Engineers (IEEE) 1394 serial port, a Universal Serial Bus (USB) port, an IR interface, and the like. The computing system 10 may also include the communications interface 92 suitable for communicating with the network 20 as appropriate or desired. The computing system 10 may also include a video port configured to interface with the display device, to provide information to the user.

A number of other possible implementations are supported by the above disclosure. For example, in some implementations, A cable modem device is provided. The cable modem device can include a memory and one or more processor devices coupled to the memory. The one or more processor devices are configured to detect occurrence of a secondary channel bonding condition. The one or more processor devices are configured to determine a number of DOCSIS-compatible secondary channels to bond based at least in part on a pre-configured value of a channel bonding parameter stored to the memory of the modem device, wherein the channel bonding parameter controls a maximum quantity of DOCSIS-compatible secondary channels the modem device can bond, and wherein a secondary DOCSIS-compatible channel comprises a maximum bandwidth capacity less than that of a high-bandwidth DOCSIS-compatible channel. The one or more processor devices are configured to, based on the occurrence of the secondary channel bonding condition, bond the number of DOCSIS-compatible channel secondary channels, wherein the number of DOCSIS-compatible secondary channels is less than or equal to the pre-configured value of the channel bonding parameter.

Individuals will recognize improvements and modifications to the preferred examples of the disclosure. All such improvements and modifications are considered within the scope of the concepts disclosed herein and the claims that follow.

What is claimed is:

1. A method, comprising:
sending, by a modem device to a network entity, information indicative of a current value of a channel bonding parameter of the modem device that controls a maximum quantity of secondary uplink channels the modem device can bond, wherein the modem device bonds secondary uplink channels in response to impairment of one or more high-bandwidth uplink channels;
responsive to sending the information, receiving, by the modem device from the network entity, information indicative of a replacement value for the channel bonding parameter of the modem device, wherein the replacement value is less than the current value;
replacing, by the modem device, the current value of the channel bonding parameter with the replacement value; and
based on the replacement value of the channel bonding parameter, bonding, by the modem device, a number of secondary uplink channels less than or equal to the replacement value of the channel bonding parameter of the modem device.

2. The method of claim 1, wherein, prior to sending the information indicative of the current value of the channel bonding parameter, the method comprises:
sending, by the modem device, a first portion of uplink information via the one or more high-bandwidth uplink channels;
detecting, by the modem device, channel impairment for the one or more high-bandwidth uplink channels; and
determining, by the modem device, to bond secondary uplink channels in response to detecting channel impairment for the one or more high-bandwidth uplink channels.

3. The method of claim 2, wherein detecting the channel impairment for the one or more high-bandwidth uplink channels comprises detecting, by the modem device, occurrence of Orthogonal Frequency-Division Multiplexing (OFDM) channel impairment.

4. The method of claim 2, wherein detecting the channel impairment for the one or more high-bandwidth uplink channels comprises:
receiving, by the modem device from the network entity, information indicating occurrence of channel impairment for the one or more high-bandwidth uplink channels.

5. The method of claim 2, wherein the method further comprises:
sending, by the modem device, a second portion of the uplink information via the number of secondary uplink channels less than or equal to the replacement value.

6. The method of claim 2, wherein sending the first portion of uplink information via the one or more high-bandwidth uplink channels comprises:
sending, by the modem device, the first portion of the uplink information via one or more OFDM channels.

7. The method of claim 6, wherein bonding the number of secondary uplink channels comprises:
based on the replacement value for the channel bonding parameter, bonding, by the modem device, a number of Data over Cable Service Interface Specification (DOCSIS) uplink channels less than or equal to the replacement value of the channel bonding parameter of the modem device.

8. The method of claim 6, wherein bonding the number of secondary uplink channels comprises:
based on the replacement value for the channel bonding parameter, bonding, by the modem device, a number of single-carrier Quadrature Amplitude Modulation (QAM) uplink channels less than or equal to the replacement value of the channel bonding parameter of the modem device.

9. The method of claim 6, wherein bonding the number of secondary uplink channels comprises:
Based on the replacement value for the channel bonding parameter, bonding, by the modem device, a number of Time-Division Multiple Access (TDMA) uplink channels less than or equal to the replacement value of the channel bonding parameter of the modem device.

10. The method of claim 1, wherein the method further comprises:
receiving, by the modem device from the network entity, information indicative of a second replacement value for the channel bonding parameter of the modem device, wherein the second replacement value is different than the replacement value;
replacing, by the modem device, the replacement value of the channel bonding parameter with the second replacement value; and
based on the second replacement value for the channel bonding parameter, bonding, by the modem device, a second number of secondary uplink channels less than or equal to the second replacement value of the channel bonding parameter of the modem device.

11. The method of claim 1, wherein replacing the current value of the channel bonding parameter with the replacement value comprises:
applying, by the modem device, a modification to configuration information of the modem device, wherein the configuration information comprises the channel bonding parameter, and wherein the modification replaces the current value of the channel bonding parameter with the replacement value.

12. The method of claim 1, wherein replacing the current value of the channel bonding parameter with the replacement value comprises:
applying, by the modem device, a modification to firmware of the modem device, wherein the firmware comprises the channel bonding parameter, and wherein the modification replaces the current value of the channel bonding parameter with the replacement value.

13. The method of claim 1, wherein replacing the current value of the channel bonding parameter with the replacement value comprises:
applying, by the modem device, a modification to a non-volatile memory device of the modem device, wherein the non-volatile memory device comprises the channel bonding parameter, and wherein the modification replaces the current value of the channel bonding parameter with the replacement value.

14. The method of claim 1, wherein the network entity comprises a Cable Modem Termination System (CMTS).

15. A computing system, comprising:
a memory; and
one or more processor devices coupled to the memory configured to:
receive, from a modem device, information indicative of a current value of a channel bonding parameter of the modem device that controls a maximum quantity of secondary uplink channels the modem device can bond;
determine a replacement value for the channel bonding parameter of the modem device based at least in part on contextual information indicative of a current secondary uplink channel availability and/or a predicted secondary uplink channel availability; and
provide instructions to the modem device to replace the current value of the channel bonding parameter with the replacement value.

16. The computing system of claim 15, wherein the one or more processor devices are further configured to:
receive uplink information from the modem device via a number of secondary uplink channels less than or equal to the replacement value of the channel bonding parameter of the modem device.

17. The computing system of claim 15, wherein providing the instructions to the modem device to replace the current value of the channel bonding parameter with the replacement value comprises:
sending, to the modem device, instructions to apply a modification to configuration information of the modem device, wherein the configuration information comprises the channel bonding parameter, and wherein the modification replaces the current value of the channel bonding parameter with the replacement value.

18. The computing system of claim 15, wherein providing the instructions to the modem device to replace the current value of the channel bonding parameter with the replacement value comprises:
sending, to the modem device, instructions to apply a modification to firmware of the modem device, wherein the firmware comprises the channel bonding parameter, and wherein the modification replaces the current value of the channel bonding parameter with the replacement value.

19. The computing system of claim 15, wherein providing the instructions to the modem device to replace the current value of the channel bonding parameter with the replacement value comprises:
sending, to the modem device, instructions to applying a modification to a non-volatile memory device of the modem device, wherein the non-volatile memory device comprises the channel bonding parameter, and wherein the modification replaces the current value of the channel bonding parameter with the replacement value.

20. A cable modem device, comprising:
a memory; and
one or more processor devices coupled to the memory configured to:
detect occurrence of a secondary channel bonding condition;
determine a number of DOCSIS-compatible secondary channels to bond based at least in part on a pre-configured value of a channel bonding parameter stored to the memory of the modem device, wherein the channel bonding parameter controls a maximum quantity of DOCSIS-compatible secondary channels the modem device can bond, and wherein a secondary DOCSIS-compatible channel comprises a maximum bandwidth capacity less than that of a high-bandwidth DOCSIS-compatible channel; and
based on the occurrence of the secondary channel bonding condition, bond the number of DOCSIS-compatible channel secondary channels, wherein the number of DOCSIS-compatible secondary channels is less than or equal to the pre-configured value of the channel bonding parameter.

21. A network entity, comprising:
a memory; and
one or more processor devices coupled to the memory configured to:
receive, from a modem device, information indicative of a current value of a channel bonding parameter of the modem device that controls a maximum quantity of secondary uplink channels the modem device can bond, wherein the modem device bonds secondary uplink channels in response to impairment of one or more high-bandwidth uplink channels; and
responsive to sending the information, cause reconfiguration information to be sent to the modem device, wherein the reconfiguration information is indicative of a replacement value for the channel bonding parameter of the modem device, and wherein the replacement value is less than the current value; and
detect that the modem device has bonded a number of secondary uplink channels less than or equal to the replacement value of the channel bonding parameter of the modem device.

22. The network entity of claim 21, wherein, prior to receiving the information indicative of the current value of the channel bonding parameter, the one or more processor devices are configured to:
receive, from the modem device, a first portion of uplink information via the one or more high-bandwidth uplink channels;
detect occurrence of channel impairment for the one or more high-bandwidth uplink channels utilized by the modem device; and
instruct the modem device to bond the secondary uplink channels in response to detecting channel impairment for the one or more high-bandwidth uplink channels.

23. The network entity of claim 22, wherein detecting the occurrence of the channel impairment for the one or more high-bandwidth uplink channels comprises detecting occurrence of Orthogonal Frequency-Division Multiplexing (OFDM) channel impairment.
